(19) United States
(12) Patent Application Publication
(10) Pub. No.: US 2026/0106545 A1
(43) Pub. Date: Apr. 16, 2026

(54) POWER SUPPLY CIRCUIT AND A CONTROL CIRCUIT FOR CONTROLLING A SWITCHING POWER SUPPLY CIRCUIT

(71) Applicant: Monolithic Power Systems, Inc., Kirkland, WA (US)

(72) Inventors: Rui Tu, Chengdu, Sichuan (CN); Yuxin Zhang, Chengdu, Sichuan (CN)

(21) Appl. No.: 19/359,445

(22) Filed: Oct. 15, 2025

(30) Foreign Application Priority Data
Oct. 16, 2024 (CN) 202411448172.5

(51) Int. Cl. H02M 3/157; H02M 1/00; H02M 3/158

(52) U.S. Cl. CPC H02M 3/157; H02M 1/0025; H02M 3/158

(57) ABSTRACT

A control circuit for a switching power supply circuit. When the switching power supply circuit is configured to be coupled to a downstream circuit via a first power rail, and the downstream circuit is configured to be coupled to a target load via a second power rail, the switching power supply circuit converts an input voltage to generate a first output voltage on the first power rail and a second output voltage on the second power rail. The present application utilizes both a first voltage feedback signal indicative of the first output voltage and a second voltage feedback signal indicative of the second output voltage to generate an output signal of the control circuit.

The present application claims priority to, and the benefit of, Chinese application No. 202411448172.5 filed on October 16, 2024, which is incorporated herein by reference in its entirety.

### TECHNICAL FIELD

This present application relates to a power supply circuit and a control circuit for controlling a switching power supply circuit.

### BACKGROUND

Power supply circuits, such as switching power supply circuits, are generally used to supply a regulated voltage and a current to target loads. Such target loads may include microprocessors, multi-chip modules and large-scale integrated circuit systems such as graphics processors. To guarantee the normal work of these systems, the voltage on the power rails close to these target loads must be maintained within a relatively stable operating range.

However, there may be a large impedance between an output of the switching power supply circuit and the power rail close to the target load. For example, a filter provided between the output of the switching power supply circuit and the target load to reduce ripple may introduce a large impedance. In another example, the switching power supply circuit and the target load are disposed on different package substrates, the connector used to connect different package substrates may also introduce a large impedance.

Due to the presence of these inevitable and non-negligible impedances, how to accurately and stably regulate the voltage on the power rail close to the target load is a problem that needs to be solved.

### SUMMARY

There has been provided, in accordance with an embodiment of the present disclosure, a control circuit for controlling a switching power supply circuit to solve the technical problem of inaccurate and unstable voltage regulation at the load end, which is caused by the presence of a non-negligible impedance between the output of the switching power supply circuit and the target load in the prior art.

An embodiment of the present invention provides a control circuit for controlling a switching power supply circuit. The switching power supply circuit is configurable to supply a target load via a downstream circuit. The control circuit includes a constant time generating circuit, a comparison circuit, and a logic circuit. The constant time generating circuit is configured to generate a fixed time control signal. The comparison circuit is configured to receive at least a first voltage feedback signal indicative of a first output voltage and a second voltage feedback signal indicative of a second output voltage, and further configured to generate a single pulse signal, wherein when the switching power supply circuit is configured to supply the target load, the first output voltage is provided closer to an output of the switching power supply circuit and the second output voltage is provided closer to the target load. The logic circuit is configured to receive the fixed time control signal and the single pulse signal, and generate a switch control signal for controlling the at least one controllable switch of the switching power supply circuit based on the fixed time control signal and the single pulse signal.

The present invention further provides a power supply circuit. The power supply circuit includes a switching power supply circuit, a downstream circuit, a first power rail, a second power rail, and the control circuit. The first power rail is coupled between the switching power supply circuit and the downstream circuit, and the second power rail is coupled between the downstream circuit and the target load.

The present invention further provides a control circuit, configured to control a switching power supply circuit. The switching power supply circuit is configured to supply a target load via a downstream circuit. The control circuit is further configured to provide a switch control signal, and further configured to reset the switch control signal based on the input voltage and the first voltage feedback signal, and further configured to set the switch control signal based on the first voltage feedback signal and the second voltage feedback signal.

The present invention simultaneously utilize the voltage feedback signal on the first power rail and the second power rail, so as to stably adjusts the voltage on the power rail close to the target load, , thereby overcomes the voltage drop problem caused by intermediate impedance and significantly improves the stability of the power supply system. The invention is applicable for applications requiring high voltage stability, such as microprocessors and graphics processors.

### BRIEF DESCRIPTION OF DRAWINGS

FIG. 1 illustrates a power supply circuit 100 and a control circuit 109 for controlling a switching power supply circuit according to an embodiment of the present disclosure.

FIG. 2 illustrates a power supply circuit 200 and a control circuit for controlling a switching power supply circuit according to an embodiment of the present disclosure.

FIG. 3 illustrates a power supply circuit 300 and a control circuit for controlling a switching power supply circuit according to an embodiment of the present disclosure.

FIG. 4 illustrates a power supply circuit 400 and a control circuit for controlling a switching power supply circuit according to an embodiment of the present disclosure.

### DETAILED DESCRIPTION

The specific embodiments of the present invention will be described in detail below, it should be noted that the embodiments described herein are only for illustration and are not intended to limit the present invention. In the following description, numerous specific details are disclosed in order to provide a thorough understanding of the present invention. However, it will be apparent to the persons of ordinary skill in the art that these specific details do not need to be employed to practice the present invention. In other embodiments, in order not to avoid obscuring the key points of the present invention, well-known components or circuits are not described in detail.

In the whole specification, the mention to “an embodiment”, “embodiments”, “an example” or “examples” means the particular feature, structure, or characteristic described in the embodiment or example is included in at least one embodiment of the invention. Therefore, the appearances of the phrases "in an embodiment," "in embodiments," "an example," or "examples" in various places throughout this specification are not necessarily all referring to the same embodiment or example. Throughout the application document, “coupled to” includes both direct and indirect connections. Furthermore, the particular feature, structure or characteristic can be combined in any appropriate combinations and/or sub-combinations in one or more embodiments or examples. Furthermore, the persons of ordinary skill in the art should understand that the drawings provided herein are for illustration purposes and are not necessarily drawn to scale. Same reference numerals refer to the same components. As used herein, the term "and/or" includes any and all combinations of one or more of the associated listed items.

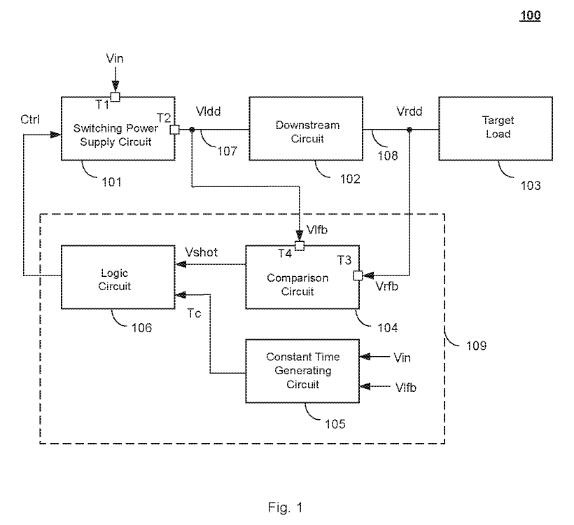

FIG. 1 illustrates a power supply circuit 100 and a control circuit 109 for controlling a switching power supply circuit according to an embodiment of the present disclosure.

As shown in FIG. 1, in an embodiment of the application, the power supply circuit 100 comprises a switching power supply circuit 101 configured to provide a voltage and a current to a target load 103. The switching power supply circuit 101 provides a first output voltage Vldd to a first power rail 107. A downstream circuit 102 is configured to receive the first output voltage Vldd from the first power rail 107 and generate a second output voltage Vrdd on a second power rail 108. Due to the presence of the downstream circuit 102, there is a phase difference between the second output voltage Vrdd and the first output voltage Vldd. Compared with the second output voltage Vrdd, the location where the first output voltage Vldd is obtained is closer to the output of the switching power supply circuit 101. In an embodiment, the first output voltage Vldd is the output voltage of the switching power circuit 101. The second output voltage Vrdd is closer to the target load 103. In an embodiment, the second output voltage Vrdd is a nominal voltage required for the target load 103 to work normally.

The switching power supply circuit 101 comprises at least one controllable switch, by controlling the on and off of the at least one controllable switch, the input voltage Vin received at a first terminal T1 is converted into an output voltage (i.e., the first output voltage Vldd) at the second terminal T2.

The power supply circuit 100 further comprises at least one control circuit 109 by controlling the on and off of the switching power supply circuit 101. The control circuit 109 comprises a constant time generating circuit 105 for generating a fixed time control signal Tc. In an embodiment, the constant time generating circuit 105 may be a constant on-time generating circuit. In another embodiment, the constant time generating circuit 105 may be a constant off-time generating circuit. The fixed time control signal Tc can be generated in a variety of ways, for example, the constant time generating circuit 105 receives at least the input voltage Vin and the first voltage feedback signal Vlfb, and generates the fixed time control signal Tc based at least on the input voltage Vin and the first voltage feedback signal Vlfb.

The control circuit 109 further comprises a comparison circuit 104. The comparison circuit 104 comprises at least a third terminal T3 and a fourth terminal T4. The fourth terminal T4 receives a first voltage feedback signal Vlfb representative of the first output voltage Vldd, and the third terminal T3 receives a second voltage feedback signal Vrfb representative of the second output voltage Vrdd. The comparison circuit 104 generates a single pulse signal Vshot for adjusting the output voltage based on at least the first voltage feedback signal Vlfb and the second voltage feedback signal Vrfb. The control circuit 109 further comprises a logic circuit 106. The logic circuit 106 receives the fixed time control signal Tc and the single pulse signal Vshot, and generates a switch control signal Ctrl for controlling the at least one controllable switch based on the fixed time control signal Tc and the single pulse signal Vshot.

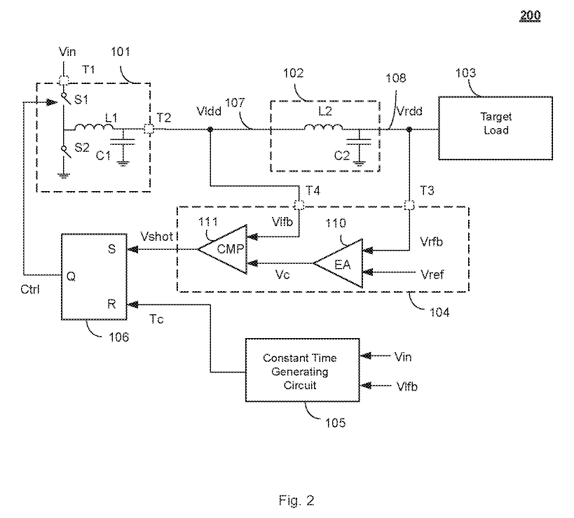

FIG. 2 shows a power supply circuit 200 according to an embodiment of the present application. In the embodiment, the switching power supply circuit 101 comprises a BUCK circuit, which comprises a first switch S1, a second switch S2, a first inductor L1 and a first capacitor C1. The first switch S1 and the second switch S2 are connected in series between the first terminal T1 and a reference ground. A common point between the first switch S1 and the second switch S2 is coupled to one end of the first inductor L1, the other end of the first inductor L1 is coupled to the second terminal T2. The first capacitor C1 is coupled between the second terminal T2 and the reference ground.

FIG. 2 shows an exemplary circuit of the downstream circuit 102. The downstream circuit 102 is coupled between the first power rail 107 and the second power rail 108. In an embodiment, the downstream circuit 102 comprises a filter for reducing the ripple of the second output voltage Vrdd. In an embodiment, the filter comprises a second inductor L2 and a second capacitor C2.

FIG. 2 illustratively shows an exemplary circuit of the comparison circuit 104. In the embodiment, the comparison circuit 104 comprises an error amplifier circuit 110, which is configured to receive the second voltage feedback signal Vrfb and a reference voltage signal Vref, and generate an error amplifier signal Vc based on the second voltage feedback signal Vrfb and the reference voltage signal Vref. The comparison circuit 104 further comprises a first voltage comparison circuit 111, which is configured to receive the error amplifier signal Vc at one input, and receive the first voltage feedback signal Vlfb at another. The first voltage comparison circuit 111 is further configured to generate the single pulse signal Vshot for adjusting the output voltage based on the error amplifier signal Vc and the first voltage feedback signal Vlfb. It can be seen that, in this embodiment, the information carried by the first voltage feedback signal Vlfb and the second voltage feedback signal Vrfb are both used to generate the single pulse signal Vshot. The principle of the comparison circuit 104 generating the single pulse signal Vshot, more specifically, the timing of generating the single pulse signal Vshot is different from the prior art. This difference ultimately ensures the stable operation of the switching power supply circuit 101 and the stability of the output voltage, and solves the low-frequency oscillation problem and the accompanying output voltage fluctuation problem.

In the embodiment of FIG. 2, the logic circuit 106 is schematically illustrated as an RS flip-flop, which comprises a set terminal S configured to receive the single pulse signal Vshot and a reset terminal R configured to receive the fixed-time control signal Tc. Based on the single pulse signal Vshot and the fixed time control signal Tc, the RS flip-flop provides the switch control signal Ctrl at its output terminal Q.

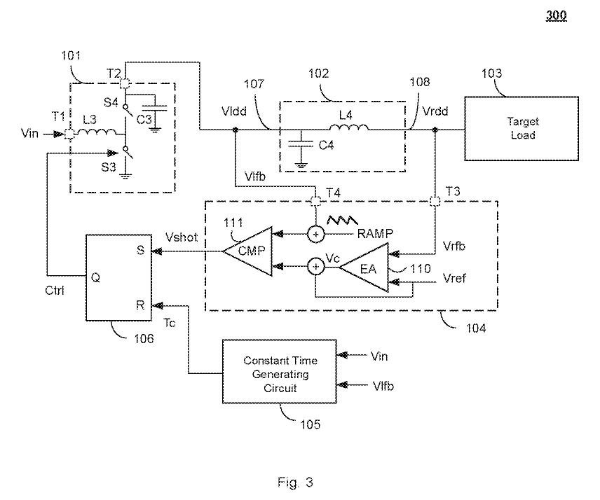

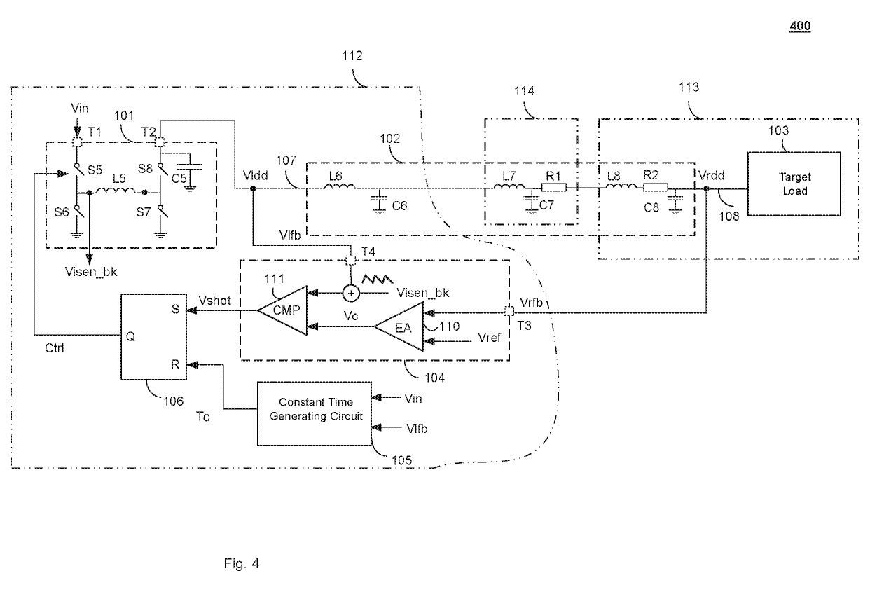

In FIG. 2, the BUCK circuit is configured to be coupled to the downstream circuit 102 via the first power rail 107. In another embodiment, the BUCK circuit may also be coupled to similar downstream circuits 102 as shown in FIG. 3andFIG. 4, or other similar downstream circuits not shown. In FIG. 2, in order to generate the switch control signal Ctrl for the BUCK circuit, the single pulse signal Vshot involved in generating the switch control signal Ctrl is provided by the comparison circuit 104 shown in FIG. 2. However, the single pulse signal Vshot may also be provided by similar comparison circuits 104 shown in FIG. 3, and FIG. 4, or other similar comparison circuits not shown.

FIG. 3 is a power supply circuit 300 according to an embodiment of the present application. In the embodiment, the switching power supply circuit 101 comprises a BOOST circuit, which comprises a third switch S3, a fourth switch S4 , a third inductor L3, and a third capacitor C3. The third switch S3 and the fourth switch S4 are connected in series between the second terminal T2 and the reference ground. A common point of the third switches S3 and the fourth switch S4 is coupled to one end of the third inductor L3, and the other end of the third inductor L3 is coupled to the first terminal T1. The third capacitor C3 is coupled between the second terminal T2 and the reference ground.

FIG. 3 shows another exemplary circuit of the downstream circuit 102. The downstream circuit 102 is coupled between the first power rail 107 and the second power rail 108. In this embodiment, the downstream circuit 102 comprises a parasitic capacitor C4, which may originate from a conductive trace or metal structure on the package substrate carrying the switching power supply circuit 101, or from a conductive trace or metal structure on the package substrate carrying the target load 103, or from a connector connecting the switching power supply circuit 101 and the target load 103.

FIG. 3 shows another exemplary circuit of the comparison circuit 104. In this embodiment, the comparison circuit 104 comprises an error amplifier circuit 110, which is configured to receive the second voltage feedback signal Vrfb and a reference voltage signal Vref, and generate an error amplifier signal Vc based on the second voltage feedback signal Vrfb and the reference voltage signal Vref. The comparison circuit 104 further comprises a first voltage comparison circuit 111, which is configured to receive the error amplifier signal Vc and the reference voltage signal Vref at one input, and receive the first voltage feedback signal Vlfb and a first ramp signal RAMP at another input. The first voltage comparison circuit 111 is further configured to generate the single pulse signal Vshot for regulating the output voltage based on the error amplifier signal Vc, the reference voltage signal Vref, the first voltage feedback signal Vlfb and the first ramp signal RAMP.

In the embodiment of FIG. 3, the logic circuit 106 is schematically illustrated as an RS flip-flop, which comprises a set terminal S configured to receive the single pulse signal Vshot and a reset terminal R configured to receive the fixed time control signal Tc. Based on the single pulse signal Vshot and the fixed time control signal Tc, the RS flip-flop provides the switch control signal Ctrl at its output terminal Q.

In FIG. 3, the BOOST circuit is configured to be coupled to the downstream circuit 102 via the first power rail 107. In another embodiment, the BOOST circuit may also be coupled to similar downstream circuits 102 as shown in FIG. 2, and FIG. 4, or other similar downstream circuits not shown. In FIG. 3, in order to generate the switch control signal Ctrl for the shown BOOST circuit, the single pulse signal Vshot that involved in generating the switch control signal Ctrl is provided by the comparison circuit 104 shown in FIG. 3. In another embodiment, the single pulse signal Vshot may also be provided by similar comparison circuits 104 shown in FIG. 2, and FIG. 4, or other comparison circuits not shown.

FIG. 4 illustratively shows a power supply circuit 400 according to an embodiment of the present application. In this embodiment, the switching power supply circuit 101 comprises a BUCK-BOOST circuit, which comprises a fifth switch S5, a sixth switch S6, a fifth inductor L5, a seventh switch S7, an eighth switch S8,and a fifth capacitor C5. The fifth switch S5 and the sixth switch S6 are connected in series between the first terminal T1 and the reference ground. The seventh switch S7 and the eighth switch S8 are connected in series between the second terminal T2 and the reference ground. A common point between the fifth switch S5 and the sixth switch S6 is coupled to one end of the fifth inductor L5, and the other end of the fifth inductor L5 is coupled to a common point between the seventh switch S7 and the eighth switch S8. The fifth capacitor C5 is coupled between the second terminal T2 and the reference ground.

FIG. 4 shows another exemplary circuit of the downstream circuit 102. The downstream circuit 102 is coupled between the first power rail 107 and the second power rail 108. In this embodiment, the downstream circuit 102 comprises capacitive components C6~C8, inductive components L6~L8, and resistive components R1 and R2. These capacitive components C6~C8 may originate from filter capacitors, conductive traces or metal structures on the package substrate carrying the switching power supply circuit 101, conductive traces or metal structures on the package substrate carrying the target load 103, and/or connectors connecting the switching power supply circuit 101 and the target load 103. These inductive components L6~L8 may originate from filter inductors, conductive traces or metal structures on the package substrate carrying the switching power supply circuit 101, conductive traces or metal structures on the package substrate carrying the target load 103, and/or connectors connecting the switching power supply circuit 101 and the target load 103. The resistive components R1 and R2 may originate from conductive traces or metal structures on the package substrate carrying the switching power supply circuit 101, conductive traces or metal structures on the package substrate carrying the target load 103, and/or connectors connecting the switching power supply circuit 101 and the target load 103.

In some embodiments, a part of the capacitive components C6~C8, the inductive components L6~L8, and the resistive components R1 and R2 (e.g., the inductive components L6 and the capacitive component C6 shown in FIG. 4) and the switching power supply circuit 101 are disposed on a first package substrate 112. In some embodiments, a part of the capacitive components C6~C8, the inductive components L6~L8, and the resistive components R1 and R2 (e.g., the capacitive component C8, the inductive component L8, and the resistive component R2 shown in FIG. 4) and the target load 103 are disposed on a second package substrate 113. In some embodiments, a part of capacitive components C6~C8, inductive components L6~L8 and resistive components R1 and R2 (e.g., the capacitive component C7, the inductive component L7 and resistive component R1 shown in FIG. 4) are disposed on a connector 114. The connector 114 is used to connect the first package substrate 112 and the second package substrate 113. In an embodiment, the first power rail 107 coupled between the switching power circuit 101 and the downstream circuit 102 is disposed on the first package substrate 112. In an embodiment, the second power rail 108 coupled between the target load 103 and the downstream circuit 102 is disposed on the second package substrate 113.

In other embodiments, the first power rail 107 and the second power rail 108 are disposed on a same package substrate. The capacitive components C6~C8, the inductive components L6~L8, and the resistive components R1 and R2 are also disposed on the substrate.

FIG. 4 also shows yet another exemplary circuit of the comparison circuit 104. In this embodiment, the comparison circuit 104 comprises an error amplifier circuit 110 and a first voltage comparison circuit 111. The error amplifier circuit 110 is configured to receive the second voltage feedback signal Vrfb and a reference voltage signal Vref, and generate an error amplifier signal Vc based on the second voltage feedback signal Vrfb and the reference voltage signal Vref. The first voltage comparison circuit 111 is configured to receive the error amplifier signal Vc at one input and receive the first voltage feedback signal Vlfb and a current sensing signal Visen_bk at another input. The current sensing signal Visen_bk is indicative of a current flowing through the fifth inductor L5. The first voltage comparison circuit 111 is further configured to generate a single pulse signal Vshot for regulating the output voltage based on the error amplifier signal Vc, the current sensing signal Visen_bk, and the first voltage feedback signal Vlfb.

In the embodiment of FIG. 4, the logic circuit 106 is schematically illustrated as an RS flip-flop, which comprises a set terminal S configured to receive the single pulse signal Vshot and a reset terminal R configured to receive the fixed time control signal Tc. Based on the single pulse signal Vshot and the fixed time control signal Tc, the RS flip-flop provides the switch control signal Ctrl at its output terminal Q. In the embodiment of FIG. 4, the control circuit for generating the switch control signal Ctrl is shown for illustrative purposes only. The persons of ordinary skill in the art would have been aware that another control circuit may be similarly provided to control switches S5 to S8 of the BUCK-BOOST circuit. This section is omitted in this application document for clarity and conciseness.

In FIG. 4, the BUCK-BOOST circuit is configured to be coupled to the downstream circuit 102 via the first power rail 107. In another embodiment, the BUCK-BOOST circuit may also be coupled to similar downstream circuits 102 as shown in FIG. 2, and FIG. 3, or other similar downstream circuits not shown. In FIG. 4, in order to generate the switch control signal Ctrl of the BUCK-BOOST circuit, the single pulse signal Vshot involved in generating the switch control signal Ctrl is provided by the comparison circuit 104 shown in FIG. 4. In another embodiment, the single pulse signal Vshot may also be provided by similar comparison circuits 104 as shown in FIG. 2, and FIG. 3, or other similar comparison circuits not shown.

While the present invention has been described with reference to several typical embodiments, it should be appreciated that the terms which have been used are words of description and illustration, rather than words of limitation. Since the present invention can be embodied in many forms without departing from the spirit or essence of the invention, it should be appreciated that the above embodiments are not limited to any of the forenamed details, but should be explained broadly within the spirit and scope defined by the appended claims, therefore, all changes and modifications that come within the scope of the claims or their equivalents are intended to be covered by the appended claims.

What is claimed is:

1. A control circuit for controlling a switching power supply circuit that is configurable to supply a target load via a downstream circuit, comprising:
a constant time generating circuit, configured to generate a fixed time control signal;
a comparison circuit, configured to receive at least a first voltage feedback signal indicative of a first output voltage and a second voltage feedback signal indicative of a second output voltage, and further configured to generate a single pulse signal, wherein when the switching power supply circuit is configured to supply the target load, the first output voltage is provided closer to an output of the switching power supply circuit and the second output voltage is provided closer to the target load; and
a logic circuit, configured to receive the fixed time control signal and the single pulse signal, and generate a switch control signal for controlling at least one controllable switch of the switching power supply circuit based on the fixed time control signal and the single pulse signal.

2. The control circuit of claim 1, wherein the first power rail and the switching power supply circuit are both disposed on a first package substrate, and the second power rail and the target load are both disposed on a second package substrate.

3. The control circuit of claim 1, wherein the first power rail and the second power rail are both disposed on a same package substrate.

4. The control circuit of claim 1, wherein the downstream circuit includes at least a capacitive component or at least an inductive component, wherein the capacitive component is a parasitic capacitor or a filter capacitor, and the inductive component is a parasitic inductor or a filter inductor.

5. The control circuit of claim 4, wherein the at least one capacitive component or the at least one inductive component of the downstream circuit is disposed on a first package substrate together with the switching power supply circuit.

6. The control circuit of claim 4, wherein the at least one capacitive component or the at least one inductive component of the downstream circuit is disposed on a second package substrate together with the target load.

7. The control circuit of claim 4, wherein the at least one capacitive component or the at least one inductive component of the downstream circuit is disposed on a connector, wherein the connector is used to connect a first package substrate carrying the switching power supply and a second package substrate carrying the target load.

8. The control circuit of claim 1, wherein the comparison circuit comprises:
an error amplifier circuit, configured to receive the second voltage feedback signal and a reference voltage signal, and generate an error amplifier signal based on the second voltage feedback signal and the reference voltage signal; and
a first voltage comparison circuit, configured to receive at least the error amplifier signal at a first input and at least the first voltage feedback signal at a second input,
wherein the first voltage comparison circuit is configured to generate the single pulse signal based on at least the error amplifier signal and the first voltage feedback signal.

9. The control circuit of claim 8, wherein the first voltage comparison circuit is further configured to receive the error amplifier signal and the reference signal at the first input, receive a ramp signal and the first voltage feedback signal at the second input, and generate the single pulse signal based on the error amplifier signal, the reference signal, the first voltage feedback signal and the ramp signal.

10. The control circuit of claim 8, wherein the first voltage comparison circuit is further configured to receive the error amplifier signal and the reference signal at the first input, receive a current sensing signal and the first voltage feedback signal at the second input, and generate the single pulse signal based on the error amplifier signal, the reference signal, the first voltage feedback signal and the current sensing signal, wherein the current sensing signal is indicative of an inductive current of the switching power supply.

11. A power supply circuit, comprising a switching power supply circuit, a downstream circuit, a first power rail, a second power rail, and a control circuit for controlling the switching power supply circuit, wherein the power supply circuit is configured to supply power to a target load via the switching power supply circuit and the downstream circuit, wherein the first power rail is coupled between the switching power supply circuit and the downstream circuit, and the second power rail is coupled between the downstream circuit and the target load, the switching power supply circuit is configured to convert an input voltage to generate a first output voltage on the first power rail and generate a second output voltage on the second power rail, wherein the control circuit comprises:
a constant time generating circuit, configured to generate a fixed time control signal;
a comparison circuit, configured to generate a single pulse signal; and
a logic circuit, configured to receive the fixed time control signal and the single pulse signal, and generate a switch control signal for controlling the at least one controllable switch based on the fixed time control signal and the single pulse signal;
wherein the comparison circuit is configured to receive at least a first voltage feedback signal being indicative of the first output voltage and a second voltage feedback signal being indicative of the second output voltage.

12. The control circuit of claim 1, wherein the first output voltage is provided on a first power rail coupling the switching power supply circuit to the downstream circuit and the second output voltage is provided on a second power rail coupling the downstream circuit to the target load.

13. A control circuit for controlling a switching power supply circuit that is configurable to supply a target load via a downstream circuit, comprising:
a first terminal, configured to receive an input voltage;
a second terminal, configured to receive a first voltage feedback signal indicative of a first output voltage, wherein when the switching power supply circuit is configured to supply the target load, the first output voltage is provided closer to an output of the switching power supply circuit;
a third terminal, configured to receive a second voltage feedback signal indicative of a second output voltage, wherein when the switching power supply circuit is configured to supply the target load, the second output voltage is provided closer to the target load; and wherein
the control circuit is configured to provide a switch control signal, and further configured to reset the switch control signal based on the input voltage and the first voltage feedback signal, and further configured to set the switch control signal based on the first voltage feedback signal and the second voltage feedback signal.

14. The control circuit of claim 13, wherein the switch control signal is configured for controlling at least one controllable switch of the switching power supply circuit to switch off when being reset and is further configured for controlling the at least one controllable switch of the switching power supply circuit to switch on when being set.

15. The control circuit of claim 13, wherein the control circuit further comprising:
a constant time generating circuit, configured to receive the input voltage and the first voltage feedback signal, and further configured to generate a fixed time control signal for controlling the reset of the switch control signal.

16. The control circuit of claim 13, further comprising:
a comparison circuit, configured to receive at least the first voltage feedback signal and the second voltage feedback signal, and further configured to generate a single pulse signal for controlling the set of the switch control signal.

17. The control circuit of claim 16, wherein the control circuit further comprising:
a constant time generating circuit, configured to receive the input voltage and the first voltage feedback signal, and further configured to generate a fixed time control signal based on the input voltage and the first voltage feedback signal; and
a logic circuit, configured to receive the fixed time control signal and the single pulse signal, and further generate the switch control signal.

18. The control circuit of claim 13, wherein the downstream circuit includes at least a capacitive component or at least an inductive component, wherein the capacitive component is a parasitic capacitor or a filter capacitor, and the inductive component is a parasitic inductor or a filter inductor.

19. The control circuit of claim 18, wherein the at least one capacitive component or the at least one inductive component of the downstream circuit is disposed on a first package substrate together with the switching power supply circuit.

20. The control circuit of claim 13, wherein the first output voltage is provided on a first power rail coupling the switching power supply circuit to the downstream circuit and the second output voltage is provided on a second power rail coupling the downstream circuit to the target load.
